(19) United States
(12) Patent Application Publication
(10) Pub. No.: US 2012/0215611 A1
(43) Pub. Date: Aug. 23, 2012

(54) MY COUPON GENIE

(76) Inventors: Michael Korson, Novi, MI (US); Andrea Korson, Novi, MI (US)

(21) Appl. No.: 13/397,160

(22) Filed: Feb. 15, 2012

Related U.S. Application Data
(60) Provisional application No. 61/442,850, filed on Feb. 15, 2011.

(51) Int. Cl. G06Q 30/02

(52) U.S. Cl. 705/14.23; 705/14.26

(57) ABSTRACT

A coupon delivery and redemption method provides downloading of coupons by manufacturers and vendors to a central coupon website. A registered consumer can access the website via a computing device to select coupons for later redemption. The selected coupons are stored on a consumer mobile communication device and presented to a vendor/retailer at product checkout for redemption of the coupons.

### CROSS REFERENCE TO CO-PENDING APPLICATION

The present application claims priority benefit to the Feb. 15, 2011 filing date of provisional patent application Ser. No. 61/442,850 for MY COUPON GENIE filed in the names of Michael Korson and Andrea Korson, the content of which are incorporated herein in its entirety.

### BACKGROUND

Product coupons are distributed to entice consumers to purchase a particular manufacturer's product by giving the consumer a discount from a standard product price. Traditionally, coupons have been employed in paper form and are distributed to the consumers by mail or as newspaper inserts.

In use, the consumer, after receiving a paper coupon, takes the coupon to the retailer and presents the coupon to the retailer at the point of purchase of the product. The retailer processes the coupon by giving the consumer the discount printed on the coupon. The retailer then returns the coupon to the product manufacturer for credit of the discounted coupon amount.

Recently, the Internet has provided consumers with the opportunity to view products from a large number of manufacturers in the convenience of their home. This enables the consumer to make product decisions before going to the retailer where the product is sold. So-called electronic coupons are available over the Internet. Such coupons are printed by the consumer and are processed in the same manner as the traditional paper coupon.

However, the large number of coupons which are available, and the limited duration of available use of such coupons presents a massive task for a consumer to obtain, print and sort the coupons for the products the consumer wishes to purchase and then have the coupons available at the time of purchase at a retailer. In addition, recent trends have been moving away from electronic or e-commerce to mobile or m-commerce. The use of Internet generated coupons is incompatible with the trend toward mobile commerce using Smartphones, PDA's or Tablet computers.

It would be desirable to provide a method of distributing and redeeming coupons which addresses this problem.

### SUMMARY

A method for virtual coupon delivery and redemption is disclosed. The method includes the steps of establishing a virtual coupon delivery and redemption program in a computing device having at least one processor executing stored program instructions, registering consumers participating in the virtual coupon delivery and redemption program, entering product promotional coupons by at least one of registered retailers and product manufacturers in the virtual coupon deliver and redemption program, creating a consumer profile with a unique consumer I.D. in a computing device processor executable application on a consumer mobile device, identifying, by the application, a plurality of individual consumer selected distinct product categories for delivery of selected coupons for redemption at a retailer, enabling, by each consumer, selected ones of a plurality of categories for receiving virtual coupons entered in the virtual delivery and redemption program, and delivering the enabled virtual coupons to the application in the mobile device of the consumer for redemption of the virtual coupons by the consumer at a retailer.

The method displays all of the enabled virtual coupons at one retailer on the consumer's mobile communication device upon a geographic location match between the location of the consumer's mobile communication device and the geographic location of the one retailer.

In the method, all of the delivered, enabled virtual coupons for a consumer are tied to a unique consumer ID in the virtual coupon delivery and redemption program.

Upon product checkout at a retailer, a consumer presents the unique consumer ID to the retailer for redemption of all of the delivered virtual coupons which match products purchased by the consumer at the retailer.

By the method, the virtual coupons are delivered to the consumer's mobile communication device either periodically, at a selected date, at a selected time of day, upon issuance of the virtual coupons by the retailer and/or the product manufacturer, and upon a geographic location match between the consumer's mobile communication device and the geographic location of the retailer.

The manufacturers and/or vendor/retailer may issue a validity period for each virtual coupon. The validity period may expire on one of a preset date, a preset time on a preset day, or when a maximum number of virtual coupons for one product have been redeemed by consumers at the one retailer or in all retailers which carry products covered by one coupon.

The method is embodied in a computer program executed by a processor and presented on website accessible by the manufacturers, vendors and consumers through the Internet.

The method reports the redemption of each coupon at all any retailer in real time or to the program website. The report of each coupon redemption can be accumulated by the program website for subsequent delivery to the vendor and/or product manufacturer in real time upon the occurrence of each coupon redemption or in periodic groups at preset times, such as a time, such as hourly, daily, weekly, monthly, etc.

In another aspect, a method for virtual coupon delivery is disclosed which includes the steps of selecting, by a consumer, via a computing device selected ones of a plurality of available coupons, storing representations of the selected coupons in the consumer mobile communication device, and presenting the selected coupons via the consumer's mobile communication device at a retailer product checkout.

In this method, the selected coupons are tied to a unique consumer identification. Upon product checkout at a retailer, the unique consumer identification is presented by the consumer to the retailer to enable the application of the selected coupons to product purchases by the consumer.

In the event of a geographic location match, all of available coupons for products offered for sale by the retailer are displayed on the consumer's mobile communication device for selection by the consumer. The selected coupons are presented via the consumer's mobile communication device at product checkout at the retailer.

### BRIEF DESCRIPTION OF THE DRAWING

The various features, advantages and other uses of the present virtual coupon delivery and redemption method will become more apparent by referring to the following detailed description and drawing in which:

FIG. 1 is a pictorial representation of an apparatus for use in a coupon delivery and redemption method;

FIG. 2 is a block diagram of an architecture overview of the coupon delivery redemption apparatus shown in FIG. 1;

FIG. 3 is a block diagram of an overview of the website shown in FIGS. 1 and 2;

FIG. 4A is a flow diagram of a consumer login sequence;

FIG. 4B is a flow diagram of a coupon selection, delivery and redemption process;

FIG. 5 is a pictorial representation of the various screens which are supplied by the mobile application to the consumer's mobile communication device;

FIG. 6 is a block diagram depicting consumer information and purchase information which is obtained and communicated by the apparatus shown in FIG. 1 between a manufacturer, vendor and consumer;

FIGS. 7A, 7B, 7C and 7D are pictorial representations of various screens supplied to the consumer's mobile communication device;

FIG. 8 is a pictorial representation of a consumer dashboard presented at the consumer's mobile communication device by the coupon delivery and redemption apparatus showing the consumer's available coupons and loyalty cards; and

FIG. 9 is a block diagram of a geographic network of stores associated with a particular vendor and/or product manufacturer.

### DETAILED DESCRIPTION

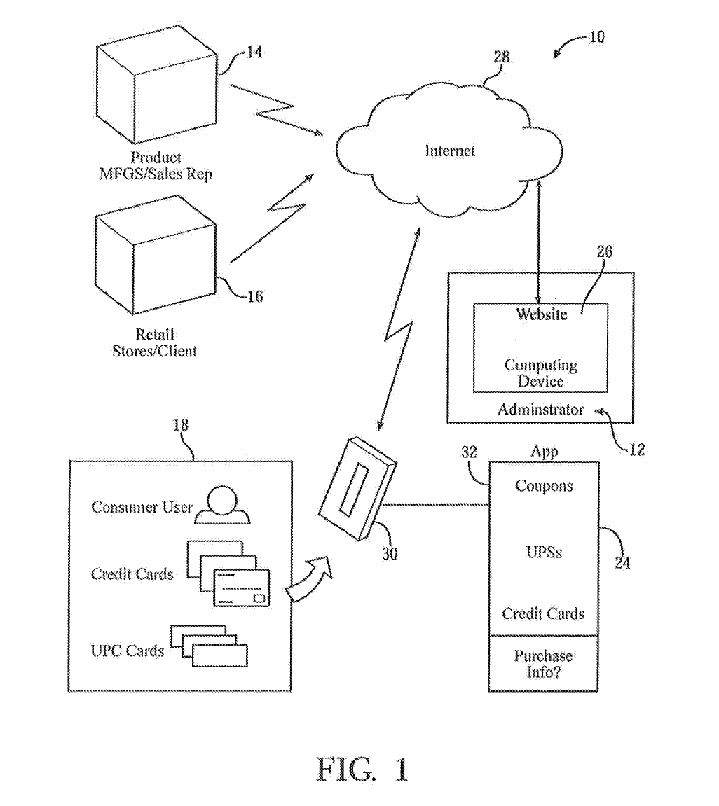

An automated coupon delivery and redemption 10 shown in FIG. 1, provides automated workflow of product coupons.

The system 10 automates coupon workflow between the following user classes:

Admin 12—the system user or group of users that monitor system stability, secure and control relationships between registered users, predefines coupon campaign variance, provides informational service support to customers, manufacturers and vendors, and gathers and provides statistics.

Manufacturer/Sales Reps 14—the owner of an industrial production line or private product business. Manufacturers produce different products and require the services of wholesalers and retailers to distribute their products. Manufacturers may have their own retailing network.

Vendor/Client 16—the owner of a store, supermarket, mall or network of brand stores, supermarkets and malls. A vendor may also be an independent coupon distribution company. Vendors may or may not have their own software for product management. A cashier is a subclass of the vendor class of users and is typically resident at the vendor site.

Consumer/User 18—an individual who makes purchases from and submits payments to manufacturers and/or vendors. Every consumer has a QR and an unique code associated with his/her identity.

The purpose of the system 10 is to automate the relations between manufacturers 14, vendors 16, and consumers 18 and provide benefits to each group. For manufacturers 14 and vendors 16, the system 10 is intended to increase sales volumes and revenues, improve marketing strategies, increase brand loyalty, decrease promotion expenditures and eliminate fraud. For consumers 18, the system 10 should provide as much savings as possible with a minimum of coupon-related actions. For the admin or project owner 12, the system will generate revenues on coupon processing operations and affiliated programs.

In the following example, only physical stores, where a consumer 18 goes to a regular check out point of sale (POS) with a cashier, are discussed. It is also possible to utilize the system with Internet shops where the consumer 18 acquires coupons from numerous online stores or sources, makes online shopping purchases, and applies the online coupons.

The system 10 functions with virtual or digital or electronic coupons. Physical paper or other coupons are not part of the system 10. The virtual coupon 24 can be issued by a product manufacturer 14 or by a vendor 16.

Coupons described hereafter can be for any type of product and service. For convenience, it will be understood that the description of product coupons will be meant to include both coupons for products as well as coupons for services, such as, oil changes, spa services, etc.

Any available communication protocol may be used to format the virtual coupon sent by the manufacturer 14 or the retailer 16 to the system 10. Such formats can include, for example only, HTML, XML, SQL, PSP, ASP PERL, TML, LISP, VBSCRIPT, JAVASCRIPT, and SOAP.

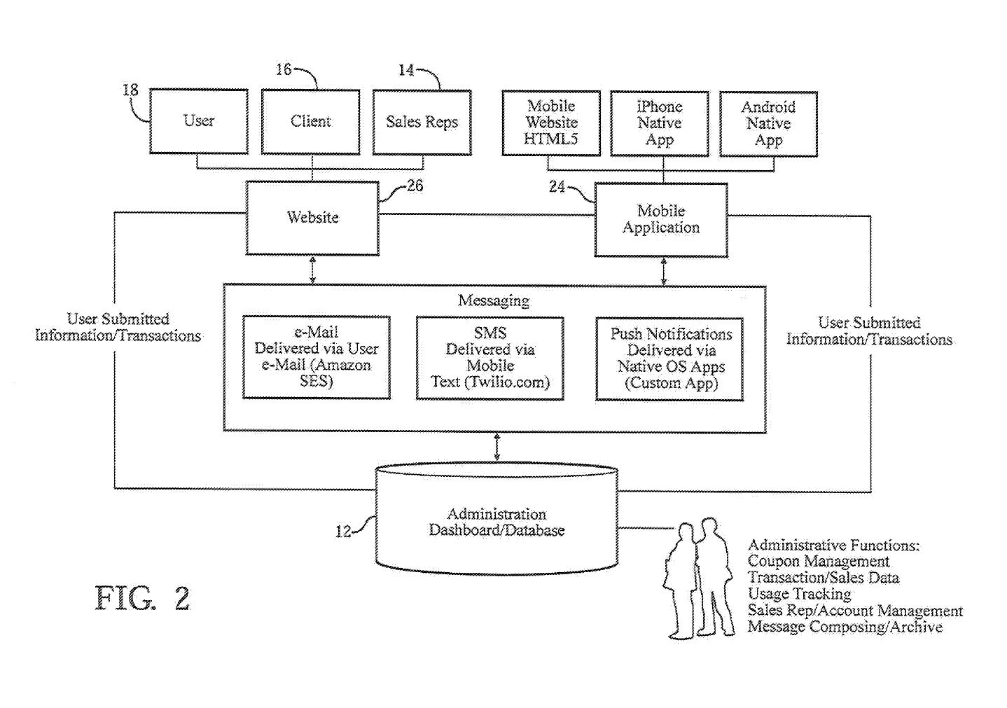

The coupon could be sent via the website 26 to the admin 12 by various means, including Email, SMS, Push Notifications, etc., as shown in FIG. 2.

The admin 12 can be embodied in a computing device using one or more processors which execute stored program control instructions stored in an onboard or remotely connectible memory incapable of executing the instructions to perform the various functions described herein as well as to create and operate the website 26.

The admin 12 maintains a website 26 accessible through the Internet 28 of the product manufacturers 14, the vendors 16 and the consumers 18. The website 26 allows the manufacturers 14 to manage coupons assigned to the manufacturer products, published products in categorized web specification form with off-load conditions, manage regular selling programs in the system, provide application forms for selling programs that support a specific calculator for the vendors, perform accounting of fixed and recurrent bargains with vendors 16, and view and manage statistics.

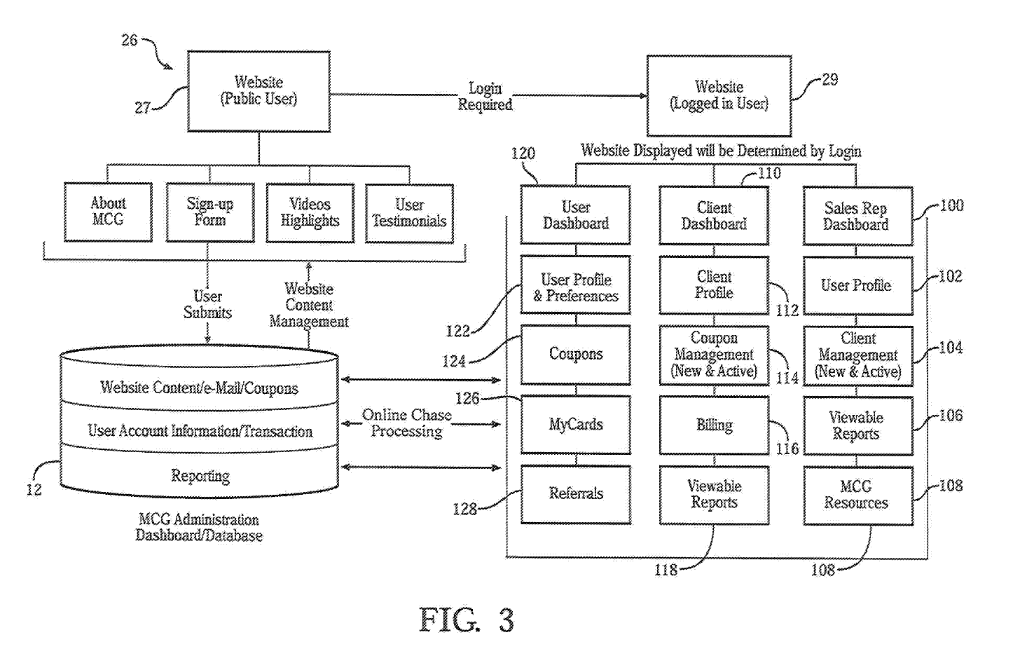

As shown in FIG. 3, the website 26 has a public user section 27 which contains information about the coupon system, consumer, vendor or product manufacturer sign up forms, as well as other information, such as video highlights and user testimonies.

Any of the consumer users, vendor users or manufacturer users can submit the appropriate information to the admin 12 which establishes a user account to track all transactions as well as the display of appropriate website content, email and coupon on the appropriate screens.

After registering, the website 26 has a log-in user section or screen 29. The website page or screen 29 will display appropriate dashboard information pertinent to the particular entity which signed in. Thus, a consumer user dashboard will displayed in the case of a consumer user log in. Similarly, a vendor/client dashboard will be displayed for the login of a vendor. A sales/rep or product manufacturer dashboard will be displayed in the case of a log in by a product manufacturer.

As shown in FIG. 3, in the case of manufacturer/sales rep. log in, a sales rep dashboard 100 will first be displayed. This will present various selections, including the user profile 102 which may be modified by the sales rep/manufacturer, client management selections 104, viewable reports 106 and system resources 108. These selections enable a product manufacture to change its user profile 102, view various coupon redemption transaction reports 106 as well as entering coupons with appropriate expiration dates, selected store presentation, selected consumer, etc., and other parameters.

In the case of a vendor/client log in, the client dashboard 110 will be displayed on a vendor screen or monitor. Like the manufacturer/sales rep website pages, the vendor/client dashboard will allow access to the vendor/client profile 112, various coupon management features 114, billing procedures 116 as well as being able to review reports 118.

The vendors 16 deal with the manufacturers 14, set mark-ups for products and publish discount offers. The discount offers can be a one time action for a single item or a set of items that can be covered by issued virtual coupons with specific redemption conditions. At the same time, the vendor 16 can set up internal recurrent coupon campaigns where specific items are automatically included.

The vendors 16 can also define a set of specific stores that make up a virtual shopping network. All promotional conditions that are applicable to one store in the network are valid for any other store in the same network.

The system 10 has the following vendor features:

1. Perform advance search in the system 10 to locate the best manufacturers and shipping conditions;

2. Register and set up a store or a network of stores;

3. Add coupons for an item or define coupons for a set of items;

4. Manage coupon campaigns;

5. Tag products for faster management and coupon campaigns or virtual network of stores;

6. Import list of products for faster set up from other formats;

7. Runs specific reports and previews statistics;

8. Broadcast email and SMS notifications to consumers subscribed to receive coupon notifications;

9. Correlate customer identity with information on available coupons relevant to the products purchased and checked out by a consumer 18; and

10. View and manage products and coupons statistics.

The login of the product manufacturer 14 and vendor 16 to the website 26 via the Internet 28 provides a unique cloud based application program interface. This eliminates the need for each product manufacturer 14 and vendors 16 to have software resident in their computer systems for distributing virtual coupons. The product manufacturers 14 and vendors 16 need only access the website 26 through the Internet 28 to download virtual coupons and receive redemption reports and other redemption tracking information from the website 26. However, the delivery of the virtual coupons to the consumer is a mobile-based delivery system using the consumer's mobile communication device 30 and its interconnection via the app 32 to the website 26.

The consumer's communication device 30 may be any computing device containing one or more processors which is capable of executing stored program control instructions stored in an on-board or in a separate remotely accessible memory.

As both manufacturers 14 and vendors 16 can issue their own coupons, the coupon entry process for both manufacturers 14 and vendors 16 is essentially the same. Upon login, each manufacturer 14 or vendor 16 can download one or a batch containing a plurality of coupons for a given time period. For each coupon, the manufacturer 14 or vendor 16 enters a number of fields, similar to the fields entered by consumer/user when setting up his/her preferences for coupon delivery. Such fields can include a number of parameters, such as gender, age, and, for most coupons, a coupon classification including a general class or category to which the coupon relates, such as sports, groceries, etc. Another field identifies the particular product associated with the coupon, such as golf clubs, yogurt, etc. The product manufacturer or brand name is entered in another field. The manufacturers 14 and the vendor/retailers 16 can issue each virtual coupon with a coupon expiration indicator. As is common with paper coupons, the expiration indicator can be an expiration date, including a month/day/year. Alternately, the coupon expiration indicator may be for a set time period within a preset day, such as from 10:00 am to 2:00 pm or Monday, Jan. 5, 2012. The coupon expiration indicator can also be unlimited or have no expiration.

In addition to the establishment of a coupon expiration indicator covering only a predetermined time period, such as four hours on a given day of the year, another real time promotion feature is available via the real time reporting of coupon redemptions by the system 10 to the vendor 16 or manufacturer 14. This real time redemption tracking feature allows the manufacturer 14 or vendor 16 to place a predetermined maximum number of product sales on a promotion instead of an expiration date. The system 10 tracks the coupon redemptions for the particular product in real time and shuts down further redemptions of coupons for purchases of the product when the maximum number of coupons set by the manufacturer 14 or the vendor 16 for a particular product has been met. This unique feature allows a manufacturer 14 or vendor 16 to place a predetermined product quantity on a given promotion, which has not been possible with prior paper or electronic coupon promotions.

After the maximum number of product coupon redemptions has been achieved, the coupon promotion will end and there will be no further delivery of coupons for that particular product to any consumer. The manufacturer 14 or vendor 16 can establish procedures to take into account the possibility of a consumer selecting a particular coupon for a product which has a maximum coupon redemption number and then, in the short time, such as a few hours, that it takes for the consumer to visit the retail store, pick up the product and take it to the vendor/retailer POS, the maximum number of coupon redemptions may have been reached. The manufacturer 14 and vendor 16 can establish rules to determine whether or not such coupons will be redeemed.

This enables the present method to deliver exact coupon results to a manufacturer and/or vendor in accordance with the manufacturer's and or vendor's preferences. In addition, the present method insures that the coupons issued by a manufacturer 14 or vendor 16 are directed to and potentially seen by the consumers 18 to which the coupons are specifically directed.

As also shown in FIG. 3, when a consumer /user logs into the website 29, the user dashboard 120 will be displayed on the consumer's mobile device 30. The consumer's communication device 30 may be any computing device containing one or more processors which is capable of executing stored programmed control instructions stored in a non-board of remotely accessible memory. Various web pages including a user profile and preferences 122, as described in greater detail hereafter, will be displayed on web page 122. Coupons available to the consumer can be displayed on page 124 along with consumer's loyalty cards 126. The consumer can also be presented with the web page allowing the consumer to pass on referrals 128 to friends and others concerning various products, restaurants, etc.

The consumers 18 are individuals who benefit from the system 10 by having registered and acquired desired coupons, either manually or as a result of automatic assigning of coupons to a particular consumer's membership card. Consumers may search the website 26 from a fixed computer location, such as a desktop computer or via a mobile communication device 30, such a Smartphone, tablet computer, etc. The consumer 18 downloads an application (hereafter app) 32 from the website 26 to enable the consumer to search the system 10 for a specific coupon in a specific location(s) and reserve the specified discount value until they reach the store and purchase and check out the particular product covered by a coupon. The consumers 18 do not need to print or clip coupons or sort them for a specific store or check the coupons for the action or end date. The consumers 18, using the app 32, can view, store and save coupons from various categories, as described hereafter.

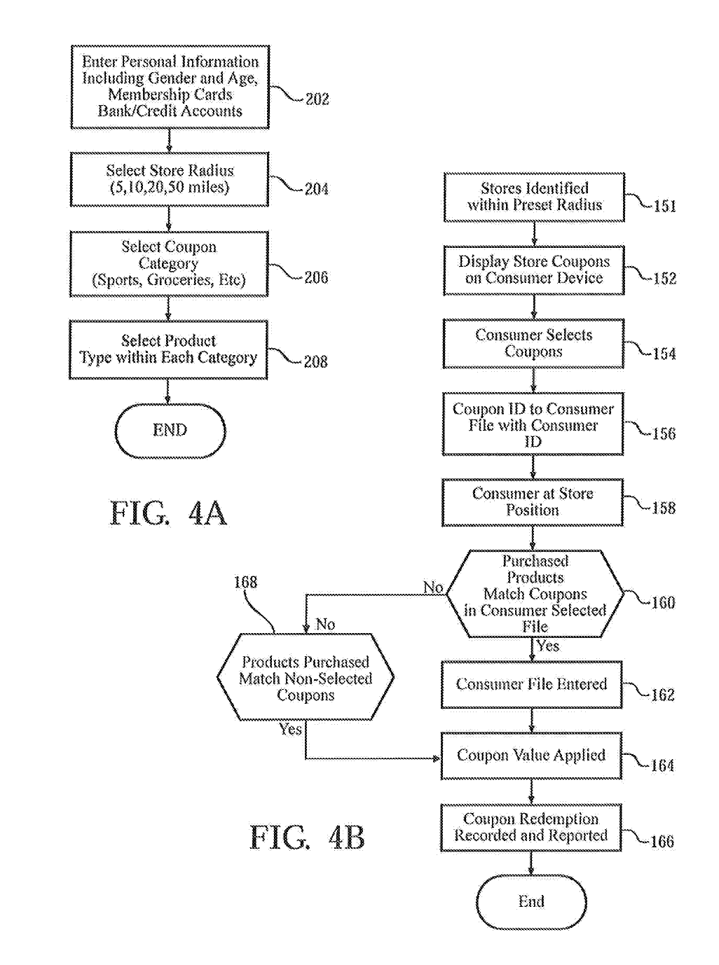

As shown in FIG. 4A, the method provides a consumer first time login via amp 32 in step 200. In step 202 the consumer/user 18 enters personal information, including name, address, credit card information for payment, loyalty cards, as well as gender and age or age range. The consumer need only enter a minimal amount of information to set up a consumer account. Such information may simply be an email request to the app 32. The consumer may enter more personal data then or later to make the system 10 work more efficiently to suit their coupon search needs.

In step 204, the consumer/user 18 is presented with a screen menu allowing a selection of a store radius from the consumer's present geographic location. The geographic radius can be any distance, with 5, 10, 20 and 50 mile radiuses shown by example only in FIG. 4A.

Next, in step 206, the user is presented with a screen, such as screen shown in 7C, which allows the consumer to select general coupon classes, such as sports, groceries, department stores, electronics, etc., for which he or she wishes to receive coupons.

In step 210, which can be optional, the user can enter or be presented with a list of brand names or manufacturer/vendor names to enable a consumer to enter the specific brand name for a product category selected in step 208.

The vendors 16 or manufacturers can enter a product type within each general product category when they enter their coupon batch into the system 10. A product type will be a specific or generic name of the product, such as yogurt, bread, milk, golf clubs, etc. The consumer 18 may be provided with an opportunity to enter a product type and/or brand name as part of his search for coupons of interest.

The system 10 utilizes intuitive software which tracks the buying habits of the registered consumers. Thus, in this manner, the system 10 learns which products a particular consumer is purchasing, by product brand name. For example, although a consumer could be presented with coupons for several different brands of yogurt, the continued selection of coupons for one particular brand of yogurt by a consumer will be recorded by the system 10 such that only coupons for that particular brand preferred by the consumer will be presented to that consumer in the future.

Next in step 151, in FIG. 4B using the geographic location feature of the consumer's mobile device or an established geographic location of the user's home computer, the system 10 identifies the stores presenting coupons in the system 10 within the consumer's pre-established or currently set store radius (see step 204). The consumer 18 has the ability to change the store radius in step 151 based on his current preference or his current location.

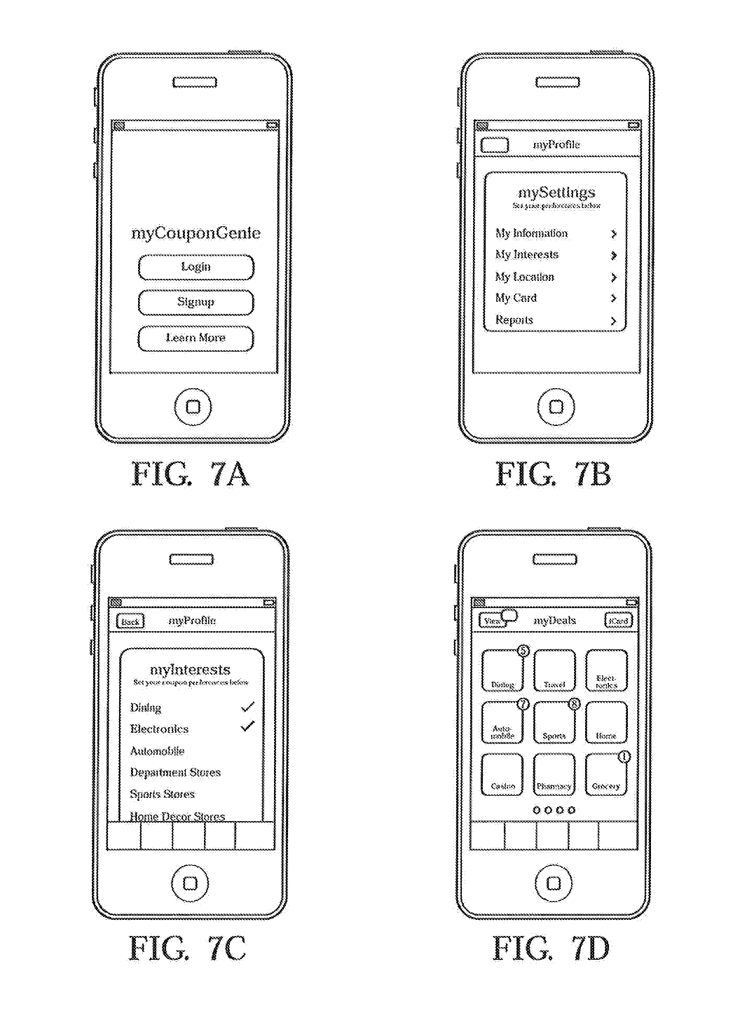

Next, as shown in FIG. 7D and in step 152 in FIG. 4B, the app 32 displays a screen identifying the various product classes under the consumer's preferences which contain current, non-expired coupons.

In step 154, the consumer can click on any product category shown in the screen in FIG. 7D to view the coupons in a particular product class.

As the consumer selects coupons in step 154, the coupon ID, which may be a bar code for other coupon identifier, is stored in the particular consumer file with a specific consumer identifier, such as a barcode, associated with the consumer. The unique consumer identifier can be a barcode or other identifier tagged to the consumer's membership number in the program. This same consumer identifier or barcode is used for all coupons selected by the consumer in any visit to a registered vendor/retailer. The file contains all of the coupons selected by a consumer for a particular trip to a selected vendor/retailer 16.

The unique consumer identifier or barcode also links to all existing consumer memberships, such as a grocery store loyalty card, an airline mileage card, a hotel rewards card, etc.

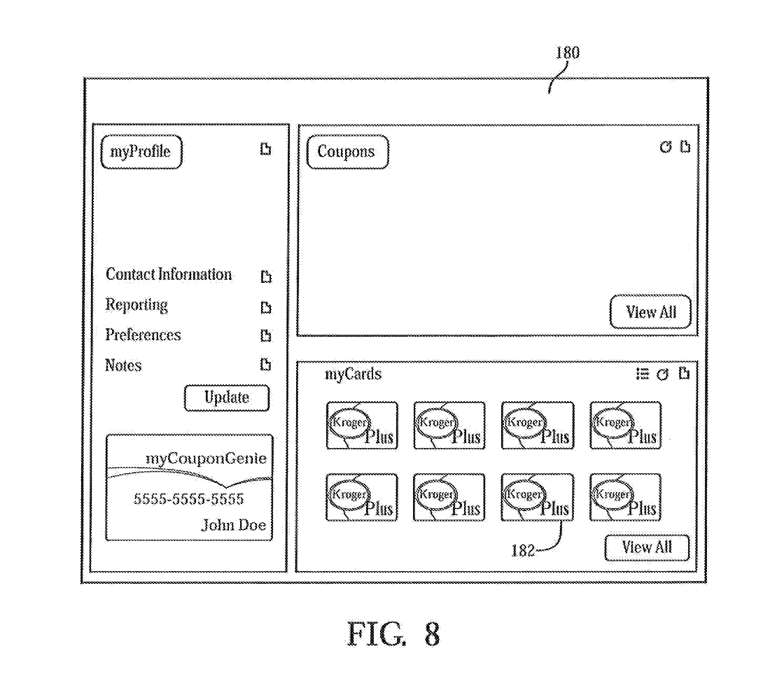

The system 10 also contemplates the delivery of a hard card, such as a card similar to that depicted on the screen in FIG. 8, identifying the consumer as a member of the program 10 and containing relevant consumer information, such as the unique consumer ID or barcode. This hard card does not have to be employed at product checkout, but can be used by the consumer as a primary or backup identification instead of a scan of the consumer's mobile communication device 30.

Next, in step 158, the system 10 determines when the geographic location of the consumer's mobile device matches the geographic location of the selected retailer in step 158. This identifies to the system 10 that the consumer has entered the retail store for purchase of products.

When the consumer is in the vendor/retail 16 store, he or she will purchase as many of the products covered by the coupons he or she preselected in step 154 as he or she can recall or find. It is common for a typical consumer, as he or she progresses through a retail store, such as a grocery store, to see and then purchase additional products. The consumer may also forget to pick up a product for a purchase which is covered by one of the preselected coupons from step 154.

Eventually, the consumer will reach the vendor/retailer 16 checkout counter point of sale (POS). As is typical, the vendor/retailer 16 scans the barcode on each product. The consumer ID shown on the screen of the consumer's mobile device, see FIG. 8, is also scanned by the retailer at the POS. The system 10 then dumps the entire consumer coupon file identified by the consumer identifier or barcode to the retailer computer system. This enables, in step 160, a match to be determined between each product scanned by the retailer at the retailer POS and the coupons contained in the consumer file selected in step 156. When a match is determined between a product and its associated coupon, in step 160, the coupon value is applied in step 164 to the consumer's product purchase total. As each coupon is matched to a particular purchased product or at the end of the consumer transaction at the vendor/retailer POS, the coupon redemption is recorded in step 166 and reported to the vendor, manufacturers, and loyalty card memberships as described above.

The application 32 in the consumer's 18 mobile communication device 30, after applying the discounted coupon amount to the products purchased by a consumer, forwards the coupon and product information via the Internet 28 to the website 26 where the data is accumulated before being made available directly to the product manufacturers 14 or vendors 16 in either raw data form instantly or as part of weekly, monthly, etc., totals and/or various statistical reports desired by each vendor 16 and manufacturer 14.

It is also common for a consumer to not preselect a coupon in step 154 for a product and then actually pick up the product for a purchase when visiting the vendor/retailer. The system 10 and method automatically searches in step 168 for each product scanned by the retailer for a particular consumer for any applicable coupons in the coupon database for that vendor/retailer 16. The system 10 automatically applies the coupon value to the consumer's purchase total and, optionally, can send a message to the consumer's mobile device that additional coupons, not preselected by the consumer, have been automatically applied by the system 10 to the consumer's total purchase amount.

Larger retailers typically have their own product/coupon computer system. The present system 10, upon consumer checkout, will automatically via the unique consumer identifier or barcode download all coupons selected by the consumer to the large retailer's computer network. The retailer's network will then search for any additional vendor branded product coupons which may be applicable to the products presently purchased by the consumer and then apply the coupons to the consumer's purchase total. Smaller retailers, who do not have a large integrated product barcode/coupon network, will use the system 10 for additional coupon search and application.

Situations may arise where multiple coupons, one from a manufacturer 14, for example, and a different one from a vendor/retailer 16, may apply to the same product currently purchased by the consumer. The system 10 will determine the highest percentage savings coupon for the consumer and then will apply that coupon to the product purchase, in the event the manufacturer or vendor allows only a single coupon to be applied to the purchase of one product.

The system 10 will also function to apply multiple purchase coupons, such as a coupon to “buy 10 of the same product and get a dollar off,” as well as purchasing a group of particular products advertised by a vendor or manufacturer to obtain a discount. The system automatically detects coupons for individual products within each group of products and applies those coupons, as well as the group purchase coupons.

The consumer interface on the consumer's mobile communication device 30 may also include a “double dip” or “double coupon” button or Icon. By selecting this button, the consumer 18 will be alerted via the admin 12 website 26 to any double coupon promotions which are available at the retailer 16 which the consumer 18 is currently visiting. Any virtual double coupon promotions which are displayed to the consumer can include double coupon promotions for products which the consumer did not initially select as potential products to be purchased.

Also, the cloud based application program interface provided by the website 26 allows manufacturers 14 and vendors/retailers 16 to communicate with each other to set up coupon promotions which may include joint coupon discounts offered by both the manufacturer 14 and the vendor/retailer 16 for particular products. In this manner, either the manufacturer 14 or the vendor/retailer 16 can post on the website 26 that they are interested in offering a particular discount amount on a particular product as part of a double coupon match. This allows participating manufacturers 14 or vendors 16 to accept the posted offer thereby creating an instant coupon promotion, which may be a double coupon promotion, using the cloud based application program interface on the website 26.

Since the consumer 18 may link his/her credit cards, debit or checking account number to his/her unique customer ID in the system 10, the system 10 can automatically charge the consumer's total purchase amount to a specific consumer credit card, debit card, bank account, etc. In this manner, a consumer 18 merely has to visit a retail store, fill the shopping cart with the products he or she wishes to purchase, confirms his identity at the checkout counter, and then leaves the store with the purchased products.

The system provides the following features for each consumer 18:

1. Register in the system through the web or mobile;

2. Manage profile details and demographic data;

3. Manage individual digital wallet and grant sensitive information for billing procedures;

4. Manage personal rating of favorite stores, products and manufacturers;

5. Setup membership cards through the web by definition of groups of wanted coupons so that they are assigned to the user's identity automatically as soon as they are available;

6. Subscribe to email and SMS coupon push programs. User will be notified by email or SMS on every bulk push in their customized areas chosen;

7. View purchase stats, loyalty points and receipts,

8. Search for products with consideration of geo location, product type and manufacturer;

9. Preview referred individual and referral stats;

10. Activate digital wallet functions that sort coupons and suggest, and

11. Employ mobile devices to access all Consumer features.

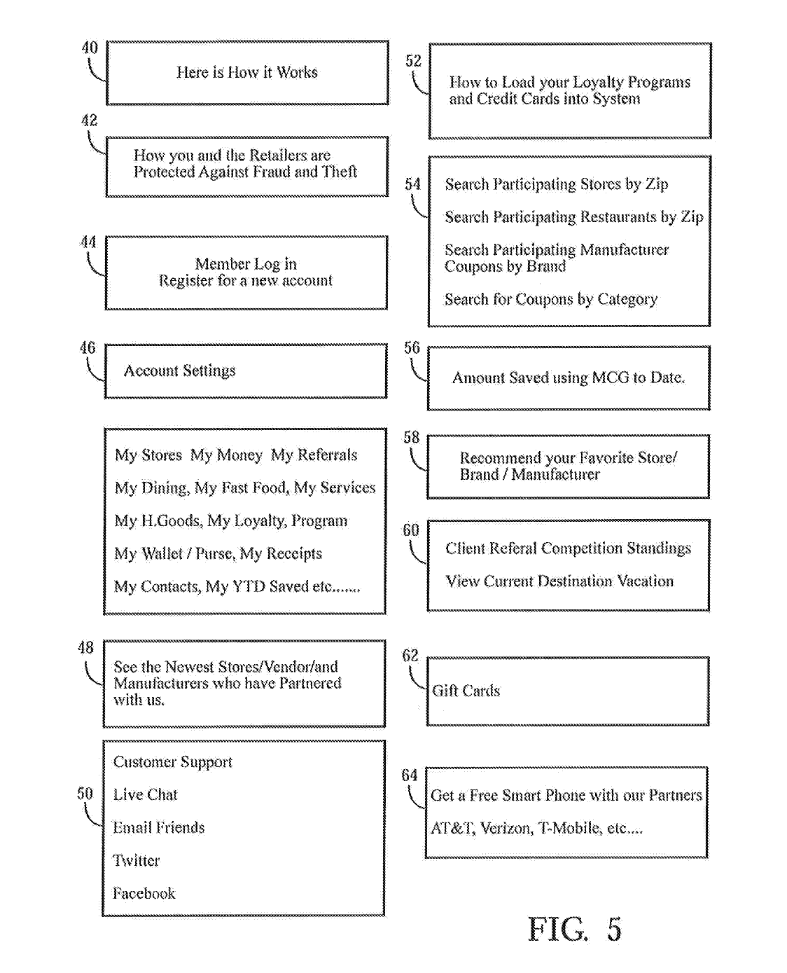

FIG. 5 depicts the various screens that can be supplied by the app 32 to the consumer's communication device 30. After introductory screens 40 and 42, a log in screen 44 is presented. The first time a consumer 18 uses the app 32; the consumer can register for a new account in the system 10. Afterward, during each log in, the consumer 18 need only enter a password to identify him or herself.

Next, the app 32 can generate account settings 46 which provide the consumer 18 with the ability to select favorite stores, dining establishments, fast food establishments, goods and loyalty programs, as well as payment options.

An optional screen 48 is available for selection by a consumer 18 to enable the consumer 18 to see the newest stores, vendors and manufacturers who have become partners in the system 10.

A customer support screen 50 may also be selected by the consumer 18 from the app 32 to provide various contacts as shown in FIG. 5.

A use screen 52 provides instructions for the consumer 18 to load loyalty program and credit card information into the system 10.

A search screen 54 can be selected by the consumer 18 to search for coupon information by various categories, such as by the zip code of participating stores, by the zip code of participating restaurants, participating manufacturers by brand or general product categories, etc.

A total amount saved using the system 10 to date is available on screen 56.

A recommendation screen 58 is also available via the app 32 to enable a consumer 18 to recommend his or her favorite store, product brand or product manufacturer.

Various promotional screens 60, 62 and 64 can also be provided by the app 32 on the consumer's mobile device 30 to advertise other products, etc. One example of a menu, as shown in FIG. 3, which is displayed on a consumer's 18 mobile device 30 by the app 32, provides touch screen areas for selecting services, entertainment, dining establishments, receipts, payment options, a grocery list, etc. After the consumer 18 signs into the web site 26 using a log in password and ID, or a thumb print scan, the app 32 sends a welcome message to the mobile device 30 for verification of the mobile device 30. The various customized, preset button locations 33 shown in FIG. 3 are then displayed to enable a consumer to search for coupons, or promotional codes from both retailers and manufacturers across the entire system 10 database from customized retailers chosen by each consumer 18 in screen 46, FIG. 5. The system 10 will sort, find and show the consumer 18 on the mobile device 30 the best coupon combinations and discounts available at the selected retailers. Then, those coupons and advertisements will be sent to the mobile device 30 of the consumer and also saved on the website 26 database for the particular consumer 18.

Each vendor 16 may access the system 10 by signing into the website 26. The vendor 16 can input coupons including coupon title, product, quantity, discount type (currency amount or percent), description, location address, location zip code, expiration date.

Alternately, the vendor 16 can upload a batch file of all coupons including the same above described information. The vendor 16 can also choose options for a type of advertisement employed with the coupons, such as database entry, push email, or SMS by range or by time.

At predetermined times, such a multiple times per day, or live updates depending upon the function needed, a MMS message blast can be sent to each consumer 18 based on retail store consumer preferences, location zip code, or actual mobile device distance from a particular retail store. The MMS message blast can contain coupon information, such as that described above. The consumer 18 can then take the mobile device 30 to the particular retail score and scan the bar code by the mobile device 30 to obtain a display on the mobile device 30 of the coupon discount amount.

The system 10 also contemplates a stored valued card coupon or UPC card, which accumulates the coupon information, and coupon amounts of all the products a particular consumer 18 wishes to purchase at a particular retail vendor store 16. This value card coupon is stored in the mobile communication device 30 of the consumer 18. The consumer 18 takes the value card on the mobile device 30 to the check out portion of the retail store for scanning. The retail store system contacts the database via the Internet 28 for SQL dimensional lookup of coupon savings for the particular customer card.

If the consumer 18 has imported their store membership loyalty card into the system 10, the system 10 will connect to the store system database for lookup of savings for a card swipe.

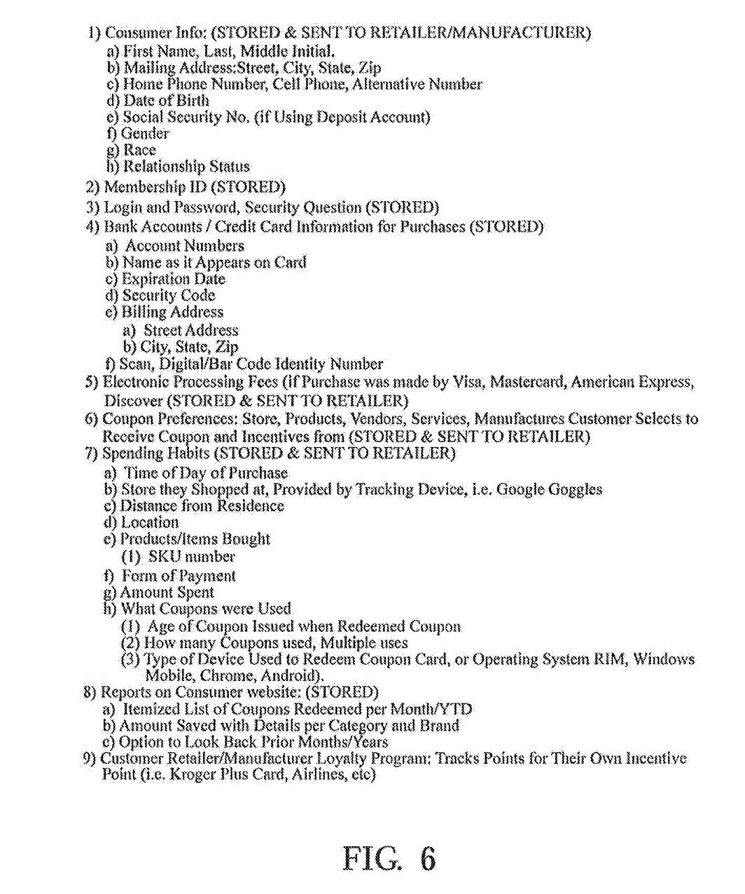

FIG. 6 lists an example of consumer information and purchase information which can be obtained and communicated by the system 10 between the manufacturer 14, the vendor 16, and each consumer 18.

FIG. 8 depicts an example of a web page presented by the app 32 on the consumer's mobile device 30 which can be displayed to show all of the coupons selected by the consumer in step 152 or step 168 in location 180 along with the consumer's loyalty card 182 for the vendor location where the consumer is presently situated.

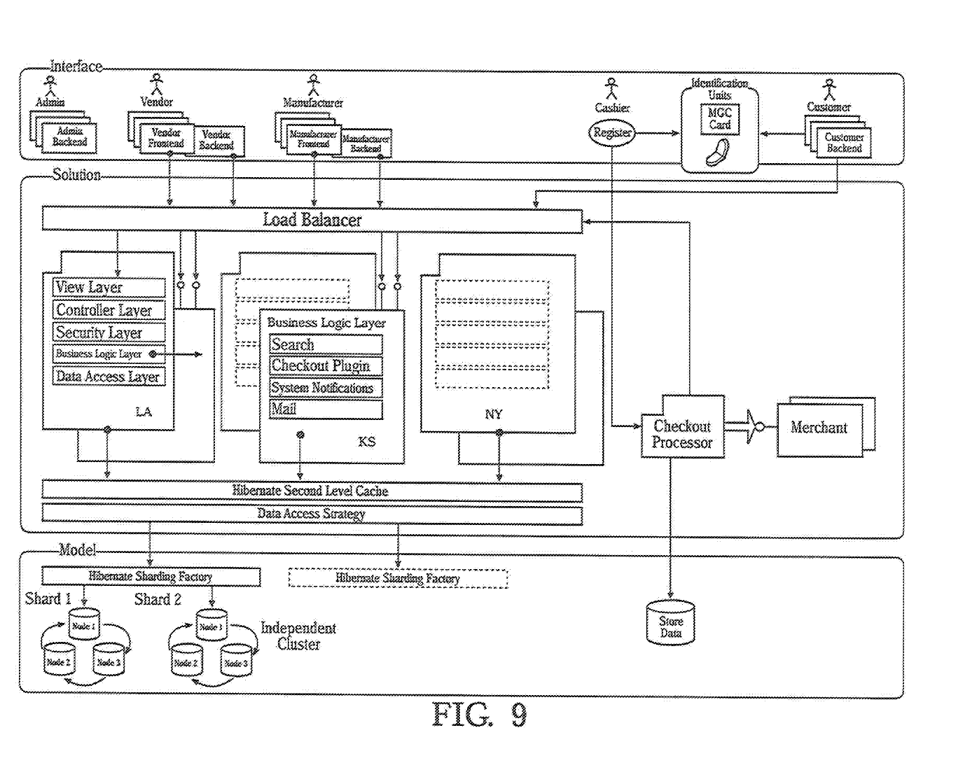

FIG. 9 depicts identical infrastructure for a network of stores associated with a particular vendor 16 or manufacturer 18 located in different states. This provides the ability for a manufacturer 14 or vendor 16 to provide coupon campaigns or advertisements for a particular state or a defined area within a state.

The process steps described above are depicted as steps in a logical flow sequence which represents a sequence of operations that can be implemented in hardware, software, or a combination of both hardware and software. For software, the block/steps represent computer-executable program instructions stored in one or more computer readable storage media that, when executed by one or more processors, performs a recited operations. The order in which the sequence/steps or computer operations are described is not intended to be construed as a specific limitation, as any number of the described steps or processes can be combined in any order and/or parallel to implement the overall process.

What is claimed is:

1. A method for virtual coupon delivery and redemption comprising:
establishing a virtual coupon delivery and redemption program in a computing device having at least one processor executing stored program instructions;
registering consumers participating in the virtual coupon delivery and redemption program;
entering product promotional coupons by at least one of registered retailers and product manufacturers in the virtual coupon deliver and redemption program;
creating a consumer profile with a unique consumer I.D. in a computing device processor executable application on a consumer mobile device;
identifying, by the application a plurality, of individual consumer selected distinct product categories for delivery of selected coupons for redemption at a retailer;
enabling, by each consumer, selected ones of a plurality of categories for receiving virtual coupons entered in the virtual delivery and redemption program; and
delivering the enabled virtual coupons to the application in the mobile device of the consumer for redemption of the virtual coupons by the consumer at a retailer.

2. The method of claim 1 comprising:
displaying all of the enabled virtual coupons at one retailer on the consumer's mobile communication device upon a geographic location match between the location of the consumer's mobile communication device and the geographic location of the one retailer.

3. The method of claim 1 comprising:
tying all of the delivered enabled virtual coupons for a consumer to a unique consumer I.D. in the virtual coupon delivery and redemption program.

4. The method of claim 3 further comprising:
upon product checkout at a retailer, presenting the unique consumer I.D. to the retailer for redemption of all of the delivered virtual coupons on matching products purchased by the consumer at the retailer.

5. The method of claim 1 further comprising:
receiving, by the consumer the delivered enabled virtual coupons on the consumer mobile communication device by one of periodically, at a selected date, at a selected time of day, upon issuance of the virtual coupons by one of the retailer and the manufacturer, and upon a geographic location match between the current geographic location of the consumer's mobile communication device and the geographic location of the retailer offering a product covered by one of the virtual enabled coupon.

6. The method of claim 1 further comprising:
issuing a validity period for each virtual coupon.

7. The method of claim 6 comprising:
creating a validity period for each issued virtual coupon wherein the validity of the virtual coupon expires on one of a preset date, a preset time on a preset day, and when a maximum number of virtual coupons for one product had been redeemed by consumers.

8. The method of claim 1 wherein:
the step of registering consumers, and registering at least one of the retailers and manufacturers is conducted, at least in part, through a wireless connection via the Internet to a website supported by a computing device including a processor executing stored program instructions.

9. The method of claim 1 comprising:
reporting by the virtual coupon delivery and redemption program, the redemption of each coupon contained in the virtual coupon delivery and redemption program in a real time upon redemption of each coupon at a retailer.

10. A method for virtual coupon delivery comprising:
selecting by a consumer via a computing device selected one of a plurality of available coupons;
storing representations of the selected coupons in the consumer mobile communication device; and
presenting the selected coupons via the consumer's mobile communication device at a retailer product checkout.

11. The method of claim 10 further comprising:
tying the selected coupons to a unique consumer identification;
upon product checkout at a retailer, presenting the unique customer identification to the retailer to apply the selected coupons to product purchases of the consumer.

12. The method of claim 10 further comprising:
determining a match between the geographic location of the consumer's mobile communication device and a geographic location of one retailer;
in the case of a geographic location match, displaying coupons on the consumer's mobile communication device available at the one retailer for selection by the consumer; and
presenting the selected coupons via the consumer's mobile communication device at product checkout at the retailer.
